(19) United States
(12) Patent Application Publication
(10) Pub. No.: US 2017/0022911 A1
(43) Pub. Date: Jan. 26, 2017

(54) CONTROL DEVICE FOR INTERNAL COMBUSTION ENGINE

(71) Applicant: TOYOTA JIDOSHA KABUSHIKI KAISHA, Toyota-shi (JP)

(72) Inventor: Eiki KITAGAWA, Susono-shi (JP)

(73) Assignee: TOYOTA JIDOSHA KABUSHIKI KAISHA, Toyota-shi (JP)

(21) Appl. No.: 15/214,920

(22) Filed: Jul. 20, 2016

(30) Foreign Application Priority Data
Jul. 22, 2015 (JP) 2015-144920

(51) Int. Cl. F02D 35/02; F02D 41/28; F02D 41/22

(52) U.S. Cl. CPC F02D 35/023; F02D 35/028; F02D 41/222; F02D 41/28; F02D 2041/281

(57) ABSTRACT

Feedback control is executed based on a measured CA10 and a measured CA50 that are calculated based on measured data for MFB. The measured data is corrected in accordance with a pattern of a waveform of measured data for a heat release amount, and measured data for MFB is calculated. A correlation index value showing a degree of correlation between the calculated measured data for MFB and reference data corresponding thereto is calculated. If the correlation index value is less than a determination value, control is performed to prohibit reflection in the aforementioned feedback control of each of the measured CA10 and the measured CA50 which are measured in the combustion cycle in which the relevant correlation index value is calculated.

### CROSS-REFERENCE TO RELATED APPLICATION

The present application claims priority to Japanese Patent Application No. 2015-144920 filed on Jul. 22, 2015, which is incorporated herein by reference in its entirety.

### BACKGROUND

Technical Field

Preferred embodiments relate to a control device for an internal combustion engine, and more particularly to a control device for an internal combustion engine that is suitable as a device for controlling an internal combustion engine that includes an in-cylinder pressure sensor.

Background Art

For example, JP 2008-069713 A discloses a combustion control device for an internal combustion engine that includes an in-cylinder pressure sensor. In the aforementioned combustion control device, data for mass fraction burned (hereunder, also referred to as “MFB”) is calculated in synchrony with the crank angle using an in-cylinder pressure sensor and a crank angle sensor, and an actual combustion starting point and a combustion center of gravity point are calculated based on the data. Furthermore, if a difference obtained by subtracting the actual combustion starting point from the combustion center of gravity point exceeds an upper limit, the combustion control device determines that combustion has deteriorated, and implements a countermeasure for improving combustion, such as increasing the fuel injection amount. Note that, in JP 2008-069713 A, as one example, an appropriate value during a period in which MFB is from 10 to 30 percent is used as the aforementioned actual combustion starting point that is a crank angle at a time that combustion is actually started in a cylinder, and, for example, an appropriate value during a period in which MFB is from 40 to 60 percent is used as the combustion center of gravity point.

The applicants are aware of the following literature, which includes the above described literature, as literature related to the present disclosure.
Patent Literature 1: JP 2008-069713 A
Patent Literature 2: JP 2010-236534 A

### SUMMARY

Noise is superimposed on an output signal of an in-cylinder pressure sensor due to various factors. In a case of performing engine control based on a crank angle when MFB becomes a specified fraction (hereunder, referred to as “specified fraction combustion point”) as described in JP 2008-069713 A, the specified fraction combustion point is calculated based on measured data for MFB. When noise is superimposed on an output signal of the in-cylinder pressure sensor, noise is also superimposed on the measured data for MFB that is based on measured data for the in-cylinder pressure. Consequently, an error that is caused by noise can arise with respect to a specified fraction combustion point that is utilized for engine control. If engine control based on a specified fraction combustion point is performed without giving any particular consideration to such noise, there is a possibility that the accuracy of the relevant engine control will deteriorate. Therefore, in the case of perform engine control based on a specified fraction combustion point, it is necessary to adopt a configuration that can appropriately detect that noise is superimposed on measured data for MFB, and to also ensure that an appropriate countermeasure is implemented if noise is detected.

With respect to detection of noise as described above, the present inventors have already studied a determination method that is based on a correlation index value that shows a degree of correlation between measured data for MFB and reference data for MFB that is based on the operating conditions of the relevant internal combustion engine, and have obtained confirmation that the determination method is effective. However, according to further studies of the present inventors it was found that the following problem arises when a strain characteristic of an in-cylinder pressure sensor changes. That is, when a strain characteristic of an in-cylinder pressure sensor changes, a difference arises between patterns of two items of measured data for MFB for which the in-cylinder combustion state is that same and which originally should match. In such a situation, even though a degree of correlation with reference data is determined as being high according to a determination that is based on measured data for MFB in a certain combustion cycle, there is a possibility that the degree of correlation with the reference data will be determined as being low according to a determination that is based on measured data for MFB in a combustion cycle after the strain characteristic changes.

Preferred embodiments address the above-described problem and have an object to provide a control device for an internal combustion engine that is configured to be capable of detecting noise that is superimposed on measured data for MFB which is calculated based on the output of an in-cylinder pressure sensor in a manner that takes into consideration a change in a strain characteristic of the in-cylinder pressure sensor, and suppressing an error at a specified fraction combustion point that is due to the noise being reflected as it is in engine control.

A control device for an internal combustion engine according to the preferred embodiments include an in-cylinder pressure sensor, a crank angle sensor, and a control unit. The in-cylinder pressure sensor is configured to detect an in-cylinder pressure. The crank angle sensor is configured to detect a crank angle. The control unit is configured to: calculate measured data for mass fraction burned that is synchronized with a crank angle, based on an in-cylinder pressure that is detected by the in-cylinder pressure sensor and a crank angle that is detected by the crank angle sensor; execute engine control in which a measured value at a specified fraction combustion point that is a crank angle at a time that mass fraction burned becomes a specified fraction is calculated based on measured data for mass fraction burned and an actuator of the internal combustion engine is controlled based on the measured value at the specified fraction combustion point; calculate a correlation index value showing a degree of correlation between the measured data for mass fraction burned and reference data for mass fraction burned which is based on operating conditions of the internal combustion engine; and prior to calculate the correlation index value, correct the measured data for mass fraction burned in a crank angle period that is after a combustion period in which mass fraction burned approaches an upper limit fraction, so that a pattern of the measured data for mass fraction burned in the crank angle period and a pattern of the reference data for mass fraction burned in the crank angle period become identical.

The control unit is also configured to: when the correlation index value is less than a determination value, prohibit reflection of a measured value at a specified fraction combustion point in a combustion cycle in which the correlation index value is calculated in the engine control, or lower a degree to which the measured value is reflected in the engine control in comparison to a case where the correlation index value is equal to or greater than the determination value.

A pattern of the reference data for mass fraction burned in the crank angle period may be a flat pattern in which mass fraction burned is constant. In this case, the control unit may also be configured to correct the measured data for mass fraction burned in the crank angle period so that a pattern of the measured data for mass fraction burned in the crank angle period becomes the flat pattern.

According to the control device according to the preferred embodiments, prior to calculate a correlation index value, measured data for mass fraction burned in a crank angle period after a combustion period in which mass fraction burned approaches an upper limit fraction is corrected so that a pattern of the measured data for mass fraction burned in the crank angle period and a pattern of the reference data for mass fraction burned in the crank angle period become identical. Hence, according to the preferred embodiments, even in a case where a difference arises in a pattern of measured data for MFB due to a strain characteristic of an in-cylinder pressure sensor, the pattern can be aligned with a pattern of reference data for MFB. In this case, if noise is superimposed on measured data for mass fraction burned, the aforementioned correlation index value decreases (indicates that the degree of correlation is low). Thus, according to the preferred embodiments, noise that is superimposed on measured data for mass fraction burned can be detected. Furthermore, according to the preferred embodiments, in a case where a correlation index value is less than a determination value, reflection of a measured value at a specified fraction combustion point in a combustion cycle in which the correlation index value is calculated in engine control is prohibited, or a degree to which the measured value is reflected in the engine control is lowered in comparison to a case where the correlation index value is not less than a determination value therefor. By this means, it is possible to suppress the occurrence of a situation in which an error at a specified fraction combustion point that is caused by noise is reflected as it is in engine control.

### BRIEF DESCRIPTION OF THE DRAWINGS

FIG. 1 is a view for describing a system configuration in an embodiment of the present disclosure;

FIG. 2 is a cross-sectional view that schematically illustrates a main section of an in-cylinder pressure sensor 30 shown in FIG. 1;

FIG. 3 is a view illustrating a waveform of MFB data;

FIG. 4 is a block diagram for describing an outline of two types of feedback control utilizing CA10 and CA50 that an ECU executes;

FIG. 5 is a view that represents a relation between an air-fuel ratio and SA-CA10;

FIG. 6 is a P-θ diagram for describing differences in the degree of influence of noise with regard to respective locations in an in-cylinder pressure waveform during a single combustion cycle;

FIG. 7 is a view for describing kinds of noise that can be superimposed on a waveform of MFB data, and problems caused by superimposition of noise;

FIG. 8 is a view for describing a noise detection technique in an embodiment of the present disclosure;

FIG. 9 is a view for describing the influence that a change in a strain characteristic of an in-cylinder pressure sensor has on a pattern of measured data for MFB in a crank angle period at a latter stage of a combustion period and in a crank angle period that is after the relevant combustion period;

FIG. 10 is a view for describing a technique for correcting measured data for MFB in the embodiment of the present disclosure; and

FIG. 11 is a flowchart illustrating a routine that an ECU 40 executes in an embodiment of the present disclosure.

### DETAILED DESCRIPTION

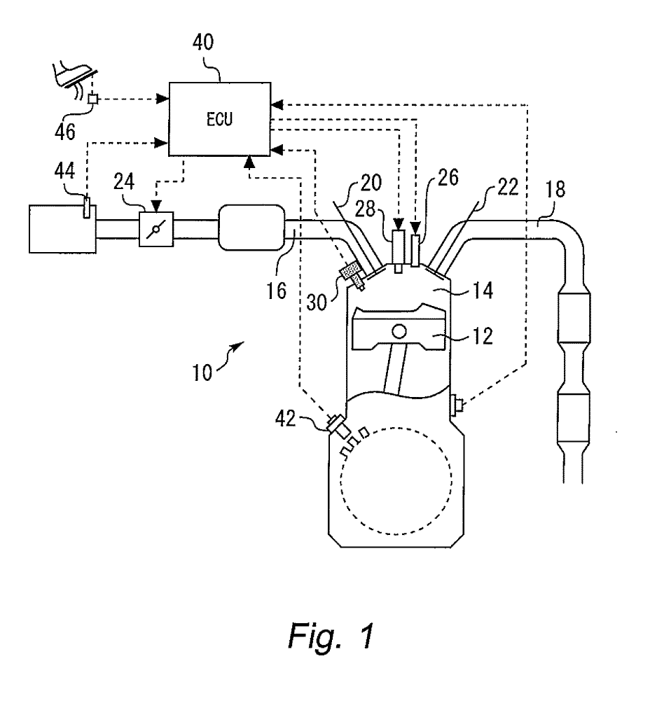

An embodiment of the present disclosure is described hereunder referring to FIG. 1 to FIG. 11.

### [System Configuration of Embodiment]

FIG. 1 is a view for describing the system configuration of an embodiment of the present disclosure. The system illustrated in FIG. 1 includes a spark-ignition type internal combustion engine 10. The internal combustion engine 10 includes a plurality of cylinders, and one of the cylinders is illustrated in FIG. 1. A piston 12 is provided in each cylinder of the internal combustion engine 10. A combustion chamber 14 is formed at the top side of the piston 12 inside the respective cylinders. An intake passage 16 and an exhaust passage 18 communicate with the combustion chamber 14.

An intake valve 20 is provided in an intake port of the intake passage 16. The intake valve 20 opens and closes the intake port. An exhaust valve 22 is provided in an exhaust port of the exhaust passage 18. The exhaust valve 22 opens and closes the exhaust port. An electronically controlled throttle valve 24 is provided in the intake passage 16. Each cylinder of the internal combustion engine 10 is provided with a fuel injection valve 26 for injecting fuel directly into the combustion chamber 14 (into the cylinder), and an ignition device (only a spark plug is illustrated in the drawings) 28 for igniting an air-fuel mixture. An in-cylinder pressure sensor 30 for detecting a pressure in the combustion chamber 14 (in-cylinder pressure) is also mounted in each cylinder.

The system illustrated in FIG. 1 also includes an ECU (electronic control unit) 40 as a control device that controls the internal combustion engine 10, and drive circuits (not shown in the drawings) for driving various actuators that are described below, and also various sensors that are described below and the like. The ECU 40 includes an input/output interface, a memory, and a central processing unit (CPU). The input/output interface is provided in order to take in sensor signals from various sensors installed in the internal combustion engine 10 or the vehicle in which the internal combustion engine 10 is mounted, and to output actuating signals to various actuators for controlling the internal combustion engine 10. Various control programs and maps and the like for controlling the internal combustion engine 10 are stored in the memory. The CPU reads out a control program or the like from the memory and executes the control program or the like, and generates actuating signals for various actuators based on sensor signals that are taken in.

The sensors from which the ECU 40 takes in signals include, in addition to the aforementioned in-cylinder pressure sensor 30, various sensors for acquiring the engine operating state such as a crank angle sensor 42 that is disposed in the vicinity of a crank shaft (not illustrated in the drawings), an air flow meter 44 that is disposed in the vicinity of an inlet to the intake passage 16, and an accelerator opening degree sensor 46 for detecting an opening degree of an accelerator pedal.

The actuators to which the ECU 40 outputs actuating signals include various actuators for controlling operation of the engine such as the above described throttle valve 24, fuel injection valve 26 and ignition device 28. The ECU 40 also has a function that synchronizes an output signal of the in-cylinder pressure sensor 30 with a crank angle, and subjects the synchronized signal to A/D conversion and acquires the resultant signal. It is thereby possible to detect an in-cylinder pressure at an arbitrary crank angle timing in a range allowed by the AD conversion resolution. In addition, the ECU 40 stores a map in which the relation between a crank angle and an in-cylinder volume is defined, and can refer to the map to calculate an in-cylinder volume that corresponds to a crank angle.

### (Configuration of In-Cylinder Pressure Sensor)

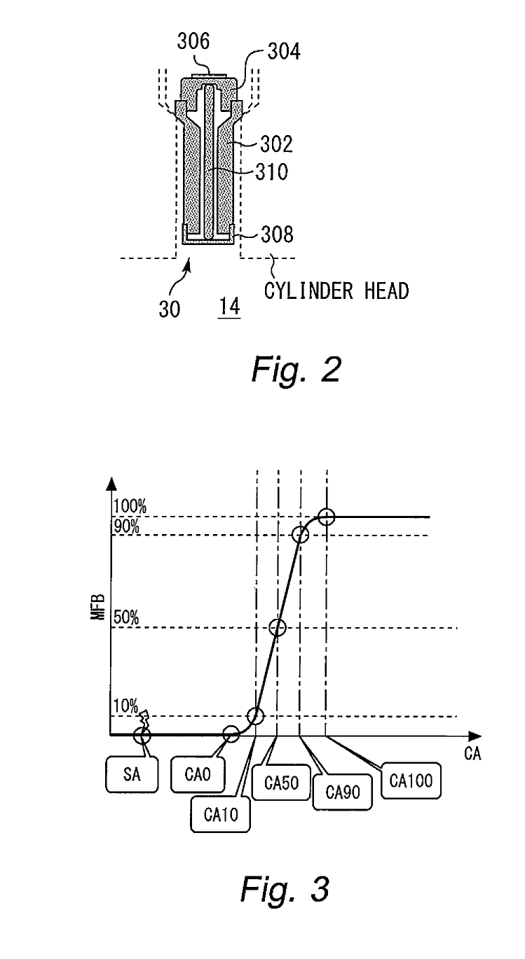

Next, the configuration of a main section of the in-cylinder pressure sensor 30 is described. FIG. 2 is a cross-sectional view that schematically illustrates a main section of the in-cylinder pressure sensor 30 shown in FIG. 1. As shown in FIG. 2, the in-cylinder pressure sensor 30 has a housing 302. The housing 302 has a hollow cylindrical structure. A housing 304 is joined to one end of the housing 302. A strain gauge element 306 in which a voltage value changes in accordance with a pressure is fixed to the housing 304.

A pressure sensing diaphragm 308 is fixed to the other end of the housing 302. The pressure sensing diaphragm 308 is a site that is exposed to gas within the combustion chamber 14 when the in-cylinder pressure sensor 30 is fixed to a cylinder head. Further, a rod 310 for transmitting a pressure that the pressure sensing diaphragm 308 receives to the strain gauge element 306 is housed in the inner space of the housing 302. A preload is continuously applied by the rod 310 to the strain gauge element 306 and the pressure sensing diaphragm 308.

### [Combustion Control in Embodiment]

(Calculation of Measured Data for MFB Utilizing in-Cylinder Pressure Sensor)

According to the system of the present embodiment that includes the in-cylinder pressure sensor 30 and the crank angle sensor 42, in each cycle of the internal combustion engine 10, measured data for an in-cylinder pressure P can be acquired in synchrony with a crank angle (more specifically, a set of in-cylinder pressures P that are calculated as values for each predetermined crank angle). A heat release amount Q inside a cylinder at an arbitrary crank angle θ can be calculated according to the following equations (1) and (2) using the measured data for the in-cylinder pressure P that is obtained and the first law of thermodynamics. Furthermore, MFB at an arbitrary crank angle θ can be calculated in accordance with the following equation (3) using the measured data for the heat release amount Q inside a cylinder that is calculated (set of heat release amounts Q calculated as values for each predetermined crank angle). Further, measured data for MFB (measured MFB set) that is synchronized with the crank angle can be calculated by executing processing to calculate the MFB at each predetermined crank angle. The measured data for MFB is calculated in a combustion period and in a predetermined crank angle period before and after the combustion period (in this case, as one example, a crank angle period from a closing timing IVC of the intake valve 20 to an opening timing EVO of the exhaust valve 22).

$$\begin{matrix}[ Expression 1 ] & \\ d Q / d θ = \frac{1}{κ - 1} \times ( V \times \frac{d P}{d θ} + P \times κ \times \frac{d V}{d θ} ) & ( 1 ) \\ Q = \sum \frac{d Q}{d θ} & ( 2 ) \\ MFB = \frac{Q ( θ ) - Q ( {θ}_{min} )}{Q ( {θ}_{max} ) - Q ( {θ}_{min} )} \times 100 & ( 3 )\end{matrix}$$

Where, in the above equation (1), V represents an in-cylinder volume and κ represents a ratio of specific heat of in-cylinder gas. Further, in the above equation (3), θₘᵢₙ represents a combustion starting point and θₘₐₓ represents a combustion end point.

According to the measured data for MFB that is calculated by the above method, a crank angle at a time that MFB is a specified fraction α (%) (hereunder, referred to as “specified fraction combustion point CAα”) can be acquired. Note that, when acquiring the specified fraction combustion point CAα, although it is also possible for a value of the specified fraction α to be successfully included in the measured data for MFB, in a case where the value is not included, the specified fraction combustion point CAα can be calculated by interpolation based on measured data located on both sides of the specified fraction α. Hereunder, in the present description, a value of CAα that is acquired utilizing measured data for MFB is referred to as “measured CAα”. A typical specified fraction combustion point CAα will now be described referring to FIG. 3 that illustrates a waveform of MFB data. Combustion in a cylinder starts accompanying an ignition delay after ignition of an air-fuel mixture is performed at an ignition timing SA. A starting point of the combustion (θₘᵢₙ in the above described equation (3)), that is, a crank angle at a time that MFB starts to rise is referred to as “CA0”. A crank angle period (CA0 to CA10) from CA0 until a crank angle CA10 that is a time that MFB becomes 10% corresponds to an initial combustion period, and a crank angle period (CA10 to CA90) from CA10 until a crank angle CA90 that is a time that MFB becomes 90% corresponds to a main combustion period. Further, according to the present embodiment, a crank angle CA50 that is a time that MFB becomes 50% is used as a combustion center of gravity point. A crank angle CA100 that is a time that MFB becomes 100% corresponds to a combustion end point (θₘₐₓ in the above described equation (3)) at which the heat release amount Q reaches a maximum value. The combustion period is defined as a crank angle period from CA0 to CA100.

### (Engine Control Utilizing CAα)

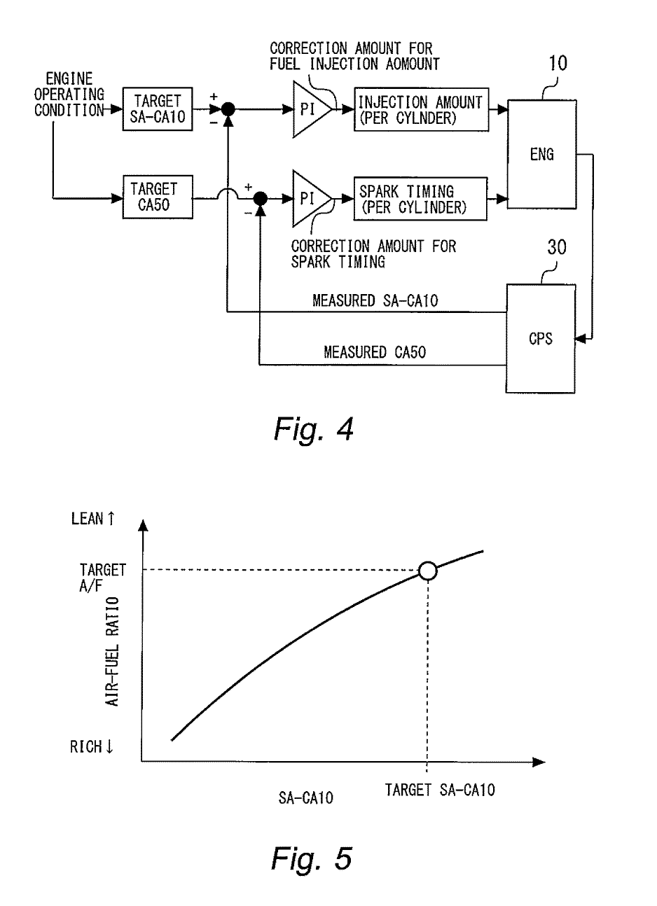

FIG. 4 is a block diagram for describing an outline of two types of feedback control utilizing CA10 and CA50 that the ECU 40 executes. The engine control that the ECU 40 performs includes control utilizing the specified fraction combustion point CAα. Here, as examples of engine control utilizing the specified fraction combustion point CAα, two types of feedback control that utilize CA10 and CA50, respectively, will be described. According to the present embodiment, these controls are executed during lean-burn operation that is performed at a larger (leaner combustion) air-fuel ratio than the theoretical air-fuel ratio.

### 1. Feedback Control of Fuel Injection Amount Utilizing SA-CA10

In this feedback control, CA10 that is the 10% combustion point is not taken as a direct target value, but is instead utilized as follows. That is, in the present description, a crank angle period from the ignition timing SA to CA10 is referred to as “SA-CA10”. More specifically, SA-CA10 that is a difference obtained by subtracting the ignition timing SA from the measured CA10 is referred to as “measured SA-CA10”. Note that, according to the present embodiment, a final target ignition timing (indicated value of ignition timing in next cycle) after adjustment by feedback control of the ignition timing utilizing CA50 as described later is used as the ignition timing SA that is used for calculating the measured SA-CA10.

FIG. 5 is a view that represents a relation between the air-fuel ratio and SA-CA10. This relation is a relation is in a lean air-fuel ratio region that is on a lean side relative to the theoretical air-fuel ratio, and is a relation under identical operating conditions (more specifically, engine operating conditions in which the intake air amount and engine speed are identical). SA-CA10 is a parameter that represents an ignition delay, and there is a constant correlation between SA-CA10 and the air-fuel ratio. More specifically, as shown in FIG. 5, in the lean air-fuel ratio region, there is a relation that SA-CA10 increases as the air-fuel ratio becomes leaner. Therefore, a target SA-CA10 that corresponds to a desired target air-fuel ratio can be determined by utilizing this relation. In addition, according to the present embodiment a configuration is adopted so that, during lean-burn operation, feedback control is executed that adjusts a fuel injection amount so that the measured SA-CA10 comes close to the target SA-CA10 (hereunder, referred to simply as “SA-CA10 feedback control”).

As shown in FIG. 4, in the SA-CA10 feedback control the target SA-CA10 is set in accordance with the engine operating conditions (more specifically, the target air-fuel ratio, the engine speed and the intake air amount). The measured SA-CA10 is calculated for each cycle in the respective cylinders. Further, in the SA-CA10 feedback control, as one example, PI control is used to adjust the fuel injection amount so that a difference between the target SA-CA10 and the measured SA-CA10 is eliminated. In the PI control, using a difference between the target SA-CA10 and the measured SA-CA10 as well as a predetermined PI gain (proportional gain and integral gain), a correction amount for the fuel injection amount is calculated in accordance with the relevant difference and the size of an integrated value thereof. A correction amount that is calculated for each cylinder is reflected in the basic fuel injection amount of the cylinder that is the object of adjustment. In this way, the fuel injection amount to be supplied in the next cycle at the relevant cylinder is adjusted (corrected) by the SA-CA10 feedback control.

According to the SA-CA10 feedback control, in a cylinder in which a measured SA-CA10 that is less than the target SA-CA10 is obtained, correction is executed that decreases the fuel injection amount to be used in the next cycle to thereby make the air-fuel ratio leaner and increase the measured SA-CA10. Conversely, in a cylinder in which a measured SA-CA10 that is greater than the target SA-CA10 is obtained, correction is executed that increases the fuel injection amount to be used in the next cycle to thereby make the air-fuel ratio richer and decrease the measured SA-CA10.

According to the SA-CA10 feedback control, by utilizing SA-CA10 that is a parameter that has a high correlation with the air-fuel ratio, the air-fuel ratio during lean-burn operation can be controlled to a target value (target air-fuel ratio). Consequently, by setting the target SA-CA10 to a value corresponding to an air-fuel ratio in the vicinity of a lean combustion limit, the air-fuel ratio can be controlled in the vicinity of the lean limit. By this means, low fuel consumption and low NOx emissions can be realized.

### 2. Feedback Control of Ignition Timing Utilizing CA50

The optimal ignition timing (so-called “MBT (minimum advance for the best torque) ignition timing”) changes according to the air-fuel ratio. Therefore, if the air-fuel ratio changes as a result of the SA-CA10 feedback control, the MBT ignition timing will also change. On the other hand, CA50 at a time that the MBT ignition timing is obtained substantially does not change with respect to the air-fuel ratio in the lean air-fuel ratio region. Therefore it can be said that, by adopting CA50 at a time that the MBT ignition timing is obtained as a target CA50, and correcting the ignition timing so that a difference between the measured CA50 and the target CA50 is eliminated, the ignition timing at a time of lean-burn operation can be adjusted to the MBT ignition timing without being affected by a change in the air-fuel ratio as is described above. Therefore, according to the present embodiment a configuration is adopted that, during lean-burn operation, together with SA-CA10 feedback control, also executes feedback control that adjusts the ignition timing so that the measured CA50 comes close to the target CA50 (hereunder, referred to simply as “CA50 feedback control”).

As shown in FIG. 4, in the CA50 feedback control, the target CA50 for making the ignition timing the MBT ignition timing is set to a value that is in accordance with the engine operating conditions (more specifically, the target air-fuel ratio, the engine speed and the intake air amount). Note that, the term “CA50 feedback control” used herein is not necessarily limited to control that controls so as to obtain the MBT ignition timing. That is, the CA50 feedback control can also be used in a case where an ignition timing other than the MBT ignition timing is adopted as a target value, such as at a time of retarded combustion. In such a case, for example, in addition to the above described engine operating conditions, it is sufficient to set the target CA50 so as to change in accordance with a target ignition efficiency (index value indicating a degree of divergence of the target value from the MBT ignition timing).

The measured CA50 is calculated for each cycle in the respective cylinders. Further, in the CA50 feedback control, as one example, PI control is used to correct the ignition timing relative to the basic ignition timing so that a difference between the target CA50 and the measured CA50 is eliminated. The basic ignition timing is previously stored in the ECU 40 as a value that is in accordance with the engine operating conditions (mainly, the intake air amount and engine speed). In the PI control, using a difference between the target CA50 and the measured CA50 as well as a predetermined PI gain (proportional gain and integral gain), a correction amount of the ignition timing is calculated that is in accordance with the relevant difference as well as the size of an integrated value of the difference. A correction amount that is calculated for each cylinder is reflected in the basic ignition timing for the cylinder that is the object of adjustment. By this means, the ignition timing (target ignition timing) to be used in the next cycle at the relevant cylinder is adjusted (corrected) by the CA50 feedback control.

A value of the air-fuel ratio at the lean combustion limit changes upon receiving the influence of the ignition timing. More specifically, for example, when the ignition timing is being retarded relative to the MBT ignition timing, the value of the air-fuel ratio at the lean combustion limit moves to the rich side in comparison to when being controlled at the MBT ignition timing. If the SA-CA10 feedback control is executed without taking into consideration the above described influence of the ignition timing on the value of the air-fuel ratio at the lean combustion limit, there is a concern that misfiring will occur in a case where the air-fuel ratio deflects to a value on the lean side due to the SA-CA10 feedback control. Therefore, according to the present embodiment, as a preferred embodiment of the SA-CA10 feedback control, a configuration is adopted in which SA-CA10 feedback control is performed only in a combustion cycle in which the CA50 feedback control is in a sufficiently converged state (that is, a state in which the ignition timing comes sufficiently close to the MBT ignition timing). Further, in order to favorably ensure the execution frequency of the SA-CA10 feedback control when performing the SA-CA10 feedback control in such a situation, according to the present embodiment a configuration is adopted in which the response speed of the CA50 feedback control is made higher than the response speed of the SA-CA10 feedback control. Such a setting of the response speed can be realized, for example, by making the PI gain to be used in the CA50 feedback control larger than the PI gain to be used in the SA-CA10 feedback control.

Note that, the SA-CA10 feedback control and the CA50 feedback control are executed for each cylinder in the above described form. Although the internal combustion engine 10 of the present embodiment includes the in-cylinder pressure sensor 30 in each cylinder, in the case of an internal combustion engine having a configuration in which, for example, an in-cylinder pressure sensor is provided in only one representative cylinder, feedback control of the fuel injection amount and the ignition timing of all the cylinders may be performed utilizing the measured SA-CA10 and the measured CA50 that are based on the in-cylinder pressure obtained from the single in-cylinder pressure sensor.

[Noise Detection Technique and Countermeasure when Noise is Detected in the Embodiment]

### (Influence of Noise on Measured Data for MFB)

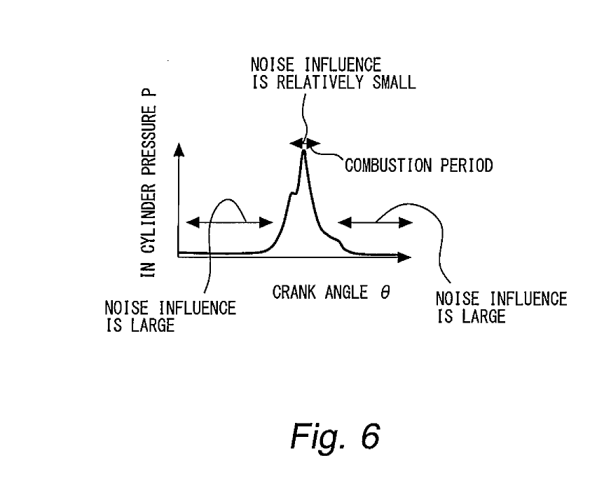

FIG. 6 is a P-θ diagram for describing differences in the degree of influence of noise with respect to respective locations of an in-cylinder pressure waveform during a single combustion cycle. Noise may sometimes be superimposed on an output signal of the in-cylinder pressure sensor 30 due to a variety of factors. However, as shown in FIG. 6, in the combustion period (CA0 to CA100) the influence of noise with respect to a measured waveform of the in-cylinder pressure during a single combustion cycle decreases in comparison to crank angle periods that are before and after the combustion period. The reason is that, in the combustion period and the vicinity thereof, the output value of the in-cylinder pressure sensor 30 is relatively large, and as a result the S/N ratio that is a ratio between the signal amount (signal) and noise amount (noise) increases. Furthermore, measured data for MFB that is calculated based on the output of the in-cylinder pressure sensor 30 is affected in the following manner by noise that is superimposed on an output signal of the in-cylinder pressure sensor 30.

Because MFB data in a combustion period is based on high-pressure in-cylinder pressure data with respect to which the degree of influence of noise is low, it can be said that the MFB data in a combustion period is less susceptible to the influence of noise in comparison to measured data for MFB in crank angle periods before and after a combustion period. Furthermore, the following can be said in relation to the influence of noise with respect to a measured value of the specified fraction combustion point CAα that is calculated based on measured data for MFB. That is, a waveform of MFB data has a characteristic such that the waveform rises rectilinearly in the main combustion period (from CA10 to CA90). Therefore, it can be said that, fundamentally, it is difficult for an error due to noise to arise at the specified fraction combustion point CAα within the main combustion period. However, because of being affected by the influence of noise that is superimposed in the crank angle periods before and after the combustion period, an error that is caused by noise is liable to arise at the combustion starting point CA0 and the combustion end point CA100 that are locations at which the waveform of MFB data bends as well as at combustion points in the vicinity of the combustion starting and ending points CA0 and CA100 (from around CA0 to CA10, and from around CA90 to CA100) in comparison to other combustion points such as the combustion center of gravity point (CA50) on the center side of the combustion period.

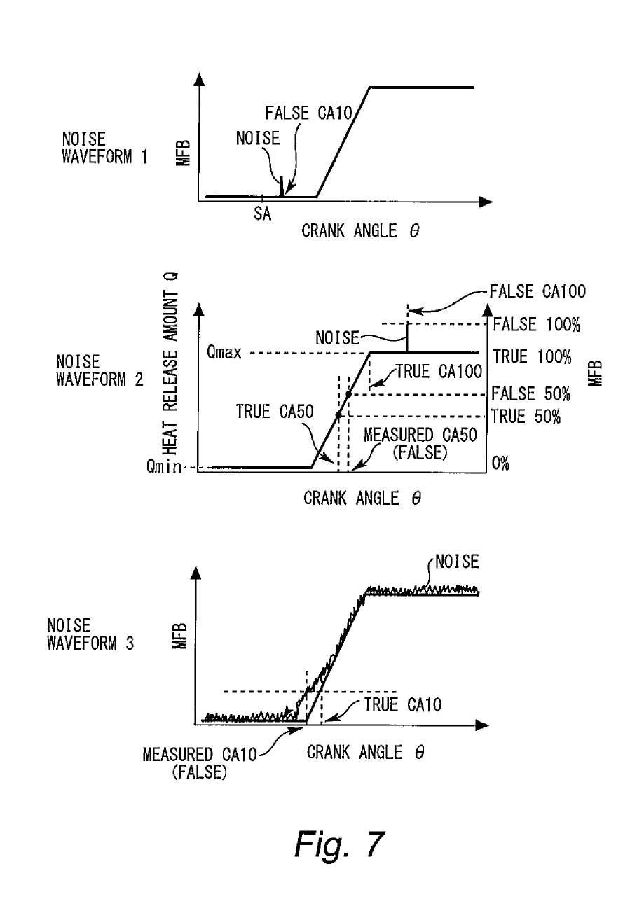

FIG. 7 is a view for describing kinds of noise that can be superimposed on a waveform of MFB data, and problems that are caused by the superimposition of noise. A noise waveform 1 shown in FIG. 7 schematically illustrates a waveform of MFB data that is based on in-cylinder pressure data in which a large amount of noise is superimposed in a spike shape at a crank angle timing that is after the ignition timing SA in a crank angle period before the combustion period. If it is assumed that a waveform of measured data for MFB acquired during execution of the above described SA-CA10 feedback control is the noise waveform 1, there is the possibility that a crank angle in the vicinity of the data at which the spike-shaped noise is superimposed will be erroneously calculated as CA10.

A noise waveform 2 shown in FIG. 7 schematically illustrates a waveform of heat release amount data that is based on in-cylinder pressure data in which a large amount of noise is superimposed in a spike shape in a crank angle period after a combustion period. The following problem arises in a case where MFB data is calculated utilizing heat release amount data in which noise is superimposed in this manner. That is, there is a possibility that a value of the heat release amount data at the crank angle timing at which noise is superimposed will be erroneously recognized as a maximum heat release amount Qₘₐₓ This means that heat release amount data at which MFB becomes 100% will be erroneously determined. Consequently, an error will arise in calculation of CA100. Thus, an error caused by noise is liable to arise at CA100 as well as combustion points in the vicinity thereof due to receiving the influence of noise that is superimposed in a crank angle period after the combustion period. Although the influence of noise that is superimposed in the form shown in the noise waveform 2 decreases as the position of the relevant combustion point is separated on the CA0 side from CA100, when the maximum heat release amount Qₘₐₓ that serves as a basis for calculating MFB is erroneously determined, this causes an error to arise in the values of other combustion points also. More specifically, as also shown in the noise waveform 2 in FIG. 7, an error also arises at combustion points in the vicinity of the center of the combustion period, such as CA50, which are combustion points that, originally, it is difficult for the influence of noise to directly affect.

A noise waveform 3 shown in FIG. 7 schematically illustrates a waveform of MFB data that is based on in-cylinder pressure data in which the same level of noise is uniformly superimposed with respect to all of a combustion period and crank angle periods before and after the combustion period. Even in a case where noise is superimposed over all of the combustion period and the crank angle periods before and after the combustion period in this manner, as long as the level of the superimposed noise is small, it can be said that even if the MFB data in which noise is superimposed is used for control, the control will not be affected thereby. However, the following problem arises in a case where noise of a comparatively large level such as in the noise waveform 3 is superimposed over a wide range. That is, because an output value of the in-cylinder pressure sensor is a relative pressure, when performing combustion analysis such as calculating MFB data based on in-cylinder pressure data, prior to the combustion analysis a correction (absolute pressure correction) is generally performed that converts the output value of the in-cylinder pressure to an absolute pressure. Since the processing for the absolute pressure correction is known, a detailed description thereof is omitted herein. In the absolute pressure correction, in-cylinder pressure data at a predetermined two crank angles during the crank angle period before the combustion period is used. When noise is superimposed in the manner shown in noise waveform 3, an error is generated in the in-cylinder pressure data for the aforementioned two points that is used for the absolute pressure correction, and hence an error also arises in the absolute pressure correction amount. Such an error in the absolute pressure correction amount is, for example, an error applied to the heat release amount data that is an error to the effect that a timing at which the heat release amount Q rises is earlier than the true timing. As a result, as also shown in the noise waveform in FIG. 7, a value at a combustion point in an initial stage of combustion, such as CA10, deviates relative to the true value. Further, an error in an absolute pressure correction amount may also affect a combustion point in the vicinity of the combustion end point CA100, such as CA90, and not just a combustion point in an initial stage of combustion, such as CA10.

### (Noise Detection Techniques)

As illustrated by way of example referring to FIG. 7, the kind of noise that can be superimposed on an output signal of the in-cylinder pressure sensor 30 is not always the same. Further, when various usage environments of the internal combustion engine 10 are supposed, it is difficult to ascertain in advance when and in what form noise that has an influence on engine control will be superimposed on an output signal. However, in the case of performing the above described SA-CA10 feedback control and CA50 feedback control based on the output of the in-cylinder pressure sensor 30, it is preferable that it is possible to appropriately detect that noise is superimposed on measured data for MFB, and that an appropriate countermeasure is taken in a case where noise is detected.

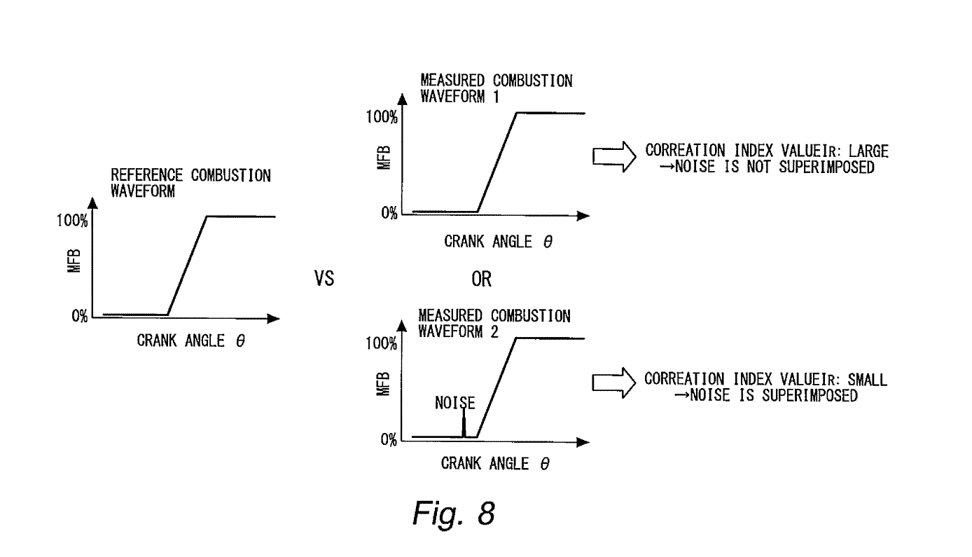

Therefore, according to the present embodiment, noise that is superimposed on measured data for MFB is detected by the following techniques. FIG. 8 is a view for describing a noise detection technique in the embodiment of the present disclosure. A reference combustion waveform shown in FIG. 8 schematically represents a waveform of reference data for MFB that is based on engine operating conditions. A measured combustion waveform 1 and a measured combustion waveform 2 shown in FIG. 8 each schematically represent a waveform of measured data for MFB. More specifically, the measured combustion waveform 1 shows an example when noise is not superimposed, while the measured combustion waveform 2 shows an example when spike-shaped noise is superimposed during a crank angle period before the combustion period (CA0 to CA100).

In the present embodiment, in order to detect noise that is superimposed on measured data for MFB, a “correlation index value I_{R}” that shows a degree of correlation between the reference data for MFB and the measured data is determined. In the present embodiment, a cross-correlation coefficient is used as a preferable technique for calculating the correlation index value I_{R}. Calculation of a cross-correlation coefficient R that uses a cross-correlation function is performed utilizing the following equation (4).

[Expression 2]

R=Σf_{a˜b}(θ)g_{a˜b}(τ_{θ}−θ) (4)

Where, in the above equation (4), θ represents a crank angle. Further, τθ is a variable that represents a relative deviation in a crank angle axis direction with respect to two waveforms that are objects for evaluation of the degree of correlation (according to the present embodiment, a reference data for MFB and a waveform of measured data). The function f_{a˜b}(θ) corresponds to reference data for MFB that is a set of discrete values that exists for each predetermined crank angle. The function g_{a˜b}(τθ−θ) corresponds to measured data for MFB that, likewise, is a set of discrete values. More specifically, (a˜b) indicates a section on the crank angle axis in which these functions f_{a˜b}(θ) and g_{a˜b}(τθ−θ) are respectively defined. The relevant section (a˜b) corresponds to a crank angle period (hereunder, referred to as “calculation period α”) in which reference data and measured data exist that are objects for calculation of the cross-correlation coefficient R (in other words, objects for evaluation of the degree of correlation) in the reference data and measured data for MFB. In the present embodiment, the calculation period α is taken as a period from the ignition timing until the opening timing (EVO) of the exhaust valve 22. Note that, in a case where measured values of the specified fraction combustion points CAα (according to the present embodiment, CA10 and CA50) that are used in the engine control are not included in the measured data for MFB that is calculated based on measured data of the in-cylinder pressure, a configuration may be adopted in which a relevant measured value is determined by interpolation based on adjacent measured data, and after also determining a value on the reference data side that serves as a counterpart in a pair with the measured value, the pair of values are included in the objects for evaluating the degree of correlation.

Performance of a convolution operation using equation (4) is accompanied by an operation that, by varying the variable τθ within a predetermined range, consecutively calculates the cross-correlation coefficient R while causing the entire waveform of the measured data for MFB within the calculation period (a) to move little by little in the crank angle direction (horizontal axis direction of the combustion waveform shown in FIG. 7) while keeping the waveform of the reference data fixed. A maximum value Rₘₐₓ of the cross-correlation coefficient R in the course of this operation corresponds to the cross-correlation coefficient R at a time that the two waveforms are closest to each other overall, and can be expressed as shown in the following equation (5). The correlation index value I_{RA} used in the present embodiment is not the maximum value Rₘₐₓ itself, but rather is a value obtained by performing predetermined normalization processing on the cross-correlation coefficient R. The term “normalization processing” used here refers to processing that is defined so that the maximum value Rₘₐₓ exhibits a value of 1 at a time that the two waveforms (waveform of reference data and waveform of measured data) are completely matching. Since this processing is known, a detailed description thereof is omitted here.

[Expression 3]

Rₘₐₓ=max(R)=max(Σf_{a˜b}(θ)g_{a˜b}(τ_{θ}−θ)) (5)

The correlation index value I_{R} calculated by the above described calculation processing becomes 1 (maximum) in a case where the two waveforms completely match, and progressively approaches zero as the degree of correlation between the two waveforms decreases. Note that, in a case where the correlation index value I_{R} exhibits a minus value, there is a negative correlation between the two waveforms, and the correlation index value I_{R} exhibits a value of −1 in a case where the two waveforms are completely inverted relative to each other. Accordingly, the degree of correlation between reference data and measured data for MFB can be ascertained on the basis of the correlation index value I_{R} that is obtained as described above. Note that, utilization of a cross-correlation function in the present embodiment is an operation that takes the same kind of data, namely MFB data, as an object and compares measured data thereof with reference data (that is, the ideal MFB data). Accordingly, it is considered that the cross-correlation function utilized in this case can be said to be substantially an auto-correlation function.

In the example illustrated in FIG. 8, in a case of the measured combustion waveform 1 in which noise is not superimposed, the correlation index value I_{R} becomes a large value (a value close to 1). On the other hand, in a case of the measured combustion waveform 2 in which spike-shaped noise is superimposed at a single location, the correlation index value I_{R} becomes a small value relative to the value in the case of the measured combustion waveform 1. A situation in which the correlation index value I_{R} becomes a small value due to superimposition of noise is not limited to a case where spike-shaped noise is superimposed at a single location, and similarly applies in a case where continual noise is superimposed as in the noise waveform 3 shown in FIG. 7. Further, the correlation index value I_{R} decreases as the level of noise that is superimposed increases. Therefore, by previously setting a determination value I_{Rth} (positive value), a determination as to whether or not noise that exceeds a certain level is superimposed on measured data for MFB can be made based on the size of the correlation index value I_{R}.

(Influence of Change in Strain Characteristic of in-Cylinder Pressure Sensor)

In this connection, as mentioned in the description of FIG. 2, the pressure sensing diaphragm 308 of the in-cylinder pressure sensor 30 is exposed to the combustion chamber 14. Consequently, a phenomenon (thermal strain) arises in which the shape of the pressure sensing diaphragm 308 changes due to being exposed to high-temperature burned gas (a combustion flame) inside the combustion chamber 14. If thermal strain arises, the amount of pressing force of the rod 310 decreases. Further, in some cases unburned fuel or soot that arises inside the combustion chamber 14 adheres to the surface of the pressure sensing diaphragm 308 or the housing 302, or the surface of a cylinder head facing the surface of the housing 302 and changes to deposits. In a case where deposits build up on these surfaces, not only does the amount of pressing force of the rod 310 decrease, but time is required for the pressure sensing diaphragm 308 to return to the original position thereof after the pressure sensing diaphragm 308 transmits the in-cylinder pressure to the rod 310. That is, a strain characteristic of the in-cylinder pressure sensor 30 changes. When the strain characteristic of the in-cylinder pressure sensor 30 changes, a difference arises between the patterns of measured data for two in-cylinder pressures P of different combustion cycles, irrespective of the fact that the combustion states inside the cylinder are the same and, originally, the patterns should match.

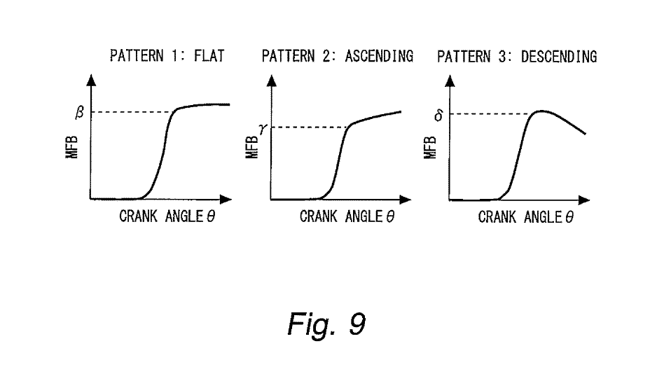

The aforementioned difference between the patterns influences a pattern of measured data for a heat release amount Q that is calculated based on measured data for the in-cylinder pressure P, and also influences a pattern of measured data for MFB that is calculated based on the heat release amount Q. Further, this influence becomes noticeable in a crank angle period at a latter stage of a combustion period (CA0-CA100) in which measured data for MFB approaches 100% (that is, an upper limit fraction), and in a crank angle period after the relevant combustion period (hereunder, also referred to as “crank angle period from the latter stage of the combustion period onward”). FIG. 9 is a view for describing the influence that a change in the strain characteristic of an in-cylinder pressure sensor has on a pattern of measured data for MFB in a crank angle period at a latter stage of a combustion period, and in a crank angle period that is after the relevant combustion period. A waveform pattern 1 shown on the left side in FIG. 9 illustrates a pattern in which MFB rises rectilinearly until a fraction β that is close to 100%, and thereafter becomes approximately constant (a flat pattern). A waveform pattern 2 shown at the center of FIG. 9 illustrates a pattern in which MFB rises rectilinearly as far as a fraction γ (<fraction β), and thereafter ascends gradually towards 100% from the fraction γ (ascending pattern). A waveform pattern 3 shown on the right side in FIG. 9 illustrates a pattern in which MFB rises rectilinearly as far as a fraction σ (≈fraction φ at which MFB is close to 100%, and thereafter descends from the fraction σ (descending pattern). As will be understood from these three waveform patterns, when a strain characteristic of the in-cylinder pressure sensor changes, a difference between the patterns of measured data for MFB is noticeable in a crank angle period from the latter stage of the combustion period onward.

If a difference arises between the patterns of measured data for MFB described in FIG. 9, naturally the aforementioned correlation index value I_{R} will exhibit differing values even though the combustion state inside the cylinder is the same. In such a situation, there is a possibility that, irrespective of the fact that noise is not actually superimposed on measured data for MFB, an erroneous determination that noise is superimposed on measured data for MFB will be made as a result of the correlation index value I_{R} exhibiting a small value. On the other hand, there is also the possibility that, irrespective of the fact that noise is actually superimposed on measured data for MFB, an erroneous determination that noise is not superimposed on measured data for MFB will be made as a result of the correlation index value I_{R} exhibiting a large value.

### (Technique for Correcting Measured Data for MFB)

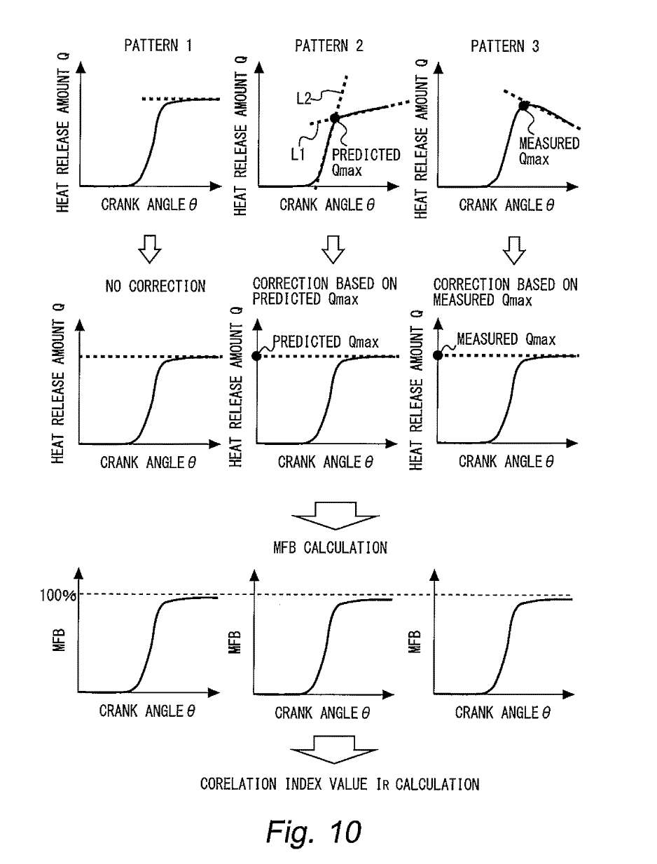

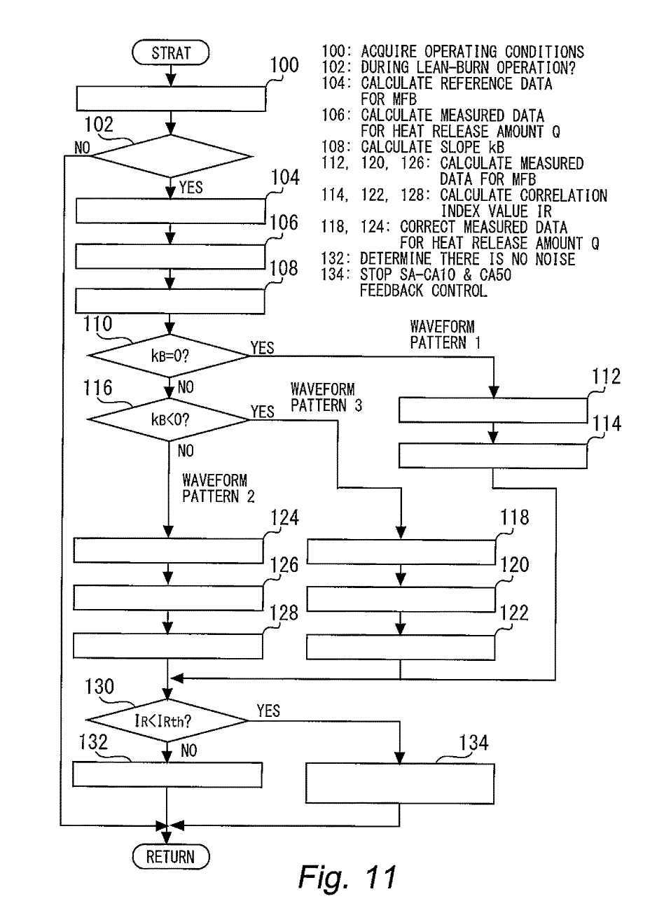

Therefore, in the present embodiment, after calculating measured data for the in-cylinder heat release amount Q using the above described equations (1) and (2), prior to calculate measured data for MFB using the above described equation (3), the measured data for the heat release amount Q is corrected in accordance with a pattern of a waveform of the measured data for the heat release amount Q that is calculated. The corrected measured data for the heat release amount Q is then substituted for Q(θ) in the above described equation (3) and the measured data for MFB is calculated. FIG. 10 is a view for describing a technique for correcting measured data for MFB in the embodiment of the present disclosure. Waveform patterns 1 to 3 of the measured data for the heat release amount Q illustrated in the upper section in FIG. 10 correspond to the waveform patterns 1 to 3 for MFB data described above referring in FIG. 9, respectively. The respective corresponding waveform patterns are approximately the same patterns. The reason is that, as will be clear from the above described equation (3), Q(θₘₐₓ) and Q(θₘᵢₙ) can be regarded as constant values because they are specified for each combustion cycle, and consequently in the above described equation (3), MFB is expressed as a linear function of Q(θ).

In the present embodiment, as shown in the upper section in FIG. 10, in a case where a waveform pattern of measured data for the heat release amount Q is the waveform pattern 1, correction of the measured data for the heat release amount Q is not performed. On the other hand, in a case where a waveform pattern of measured data for the heat release amount Q is the waveform pattern 2 and the waveform pattern 3, the measured data for the heat release amount Q is corrected. According to this correction, first, using the measured data for the heat release amount Q in FIG. 10, a crank angle θ_{Qmax} at which the heat release amount Q becomes the maximum heat release amount θₘₐₓ is identified. In this case, the waveform pattern 3 corresponds to the above described ascending pattern, and a maximum value (measured Qₘₐₓ) of the heat release amount Q that is calculated using the above described equations (1) and (2) is regarded as it is as the maximum heat release amount Qₘₐₓ. Therefore, the crank angle θ_{Qmax} can be easily identified based on measured Qₘₐₓ. In contrast, the waveform pattern 2 corresponds to the above described descending pattern, and measured Qₘₐₓ cannot be used as the maximum heat release amount Qₘₐₓ. Therefore, in the case of the waveform pattern 2, a y-coordinate (predicted Qₘₐₓ) at a point of intersection between a straight line L₁ and a straight line L₂ on an xy-plane that is shown in FIG. 10 is regarded as the maximum heat release amount Qₘₐₓ, and an x-coordinate at the point of intersection is identified as the crank angle θ_{Qmax}.

Upon the crank angle θ_{Qmax} being identified, measured data for the heat release amount Q in a crank angle interval from the crank angle θ_{Qmax} onward is used to determine a straight line that approximates the pattern of measured data for the heat release amount Q in the relevant crank angle interval. As described above, measured data for the in-cylinder pressure P is acquired as a value for each predetermined crank angle. Consequently, an approximation straight line in the crank angle interval from the crank angle θ_{Qmax} onward is determined by, for example, the least-squares method as a regression line with respect to data points (θ_{Qmax}, Qₘₐₓ), (θₙ, Qₙ), . . . , (θ_{EVO}, Q_{EVO}) on the xy-plane shown in FIG. 10. Note that, the crank angle θₙ corresponds to a detection timing with respect to the in-cylinder pressure that is immediately after the crank angle θ_{Qmax}. Further, the crank angle θ_{EVO} corresponds to the opening timing of the exhaust valve 22. To reduce the load involved in calculating the approximation straight line, a straight line that passes through two average coordinate points ((θₙ+ . . . +θ_{EVO})/h, (Qₙ+ . . . +Q_{EVO})/h) of the data points from the data point (θ_{Qmax}, Qₘₐₓ) and the data point (θₙ, Qₙ) onward may be determined as the above described approximation straight line. Note that, “h” corresponds to a total number of the data points (θₙ, Qₙ), (θ_{EVO}, Q_{EVO}).

Upon the approximation straight line being determined, the measured data for the heat release amount Q in a crank angle interval from the crank angle θ_{Qmax} onward is corrected so that a slope k_{A} of the approximation straight line is equal to 0 and a point of intersection (y-intercept) between the approximation straight line and the y-axis becomes equal to the maximum heat release amount Qₘₐₓ. The center section in FIG. 10 shows waveforms of the corrected measured data for the heat release amount Q. As shown in FIG. 10, in a case where a waveform pattern of the measured data for the heat release amount Q is the waveform pattern 2 or the waveform pattern 3, the waveform pattern can be made a similar waveform pattern (flat pattern) as the waveform pattern 1 by correcting the relevant measured data.

As described above, reference data for MFB is the ideal MFB data. As will be also understood from this fact, a waveform pattern of reference data for MFB in a crank angle period from the latter stage of the combustion period onward is a pattern that is close to the waveform pattern 1 illustrated in FIG. 9. Accordingly, by correcting the measured data for the heat release amount Q and aligning a waveform pattern of the relevant measured data with the waveform pattern 1, as shown in the lower section in FIG. 10, the waveform of the measured data for MFB can be aligned with the above described flat pattern. Hence, when calculating the above described correlation index value I_{R}, the influence of a change in the strain characteristic of the in-cylinder pressure sensor can be eliminated, and the noise detection accuracy can be increased.

(Countermeasure for Time that Noise is Detected)

In a case where SA-CA10 feedback control and CA50 feedback control are continued without change irrespective of a fact that the feedback control is being performed under circumstances in which noise is superimposed on measured data for MFB, there is a possibility that high-accuracy feedback control cannot be performed. Therefore, in the present embodiment a configuration is adopted that determines whether or not noise is superimposed on measured data for MFB based on whether or not the correlation index value I_{R} that is calculated in each combustion cycle is less than the determination value I_{Rth}.

Furthermore, in a case where the result of the aforementioned determination is affirmative, reflection of the measured CA10 and measured CA50 in the combustion cycle in which the correlation index value I_{R} that is the object of the affirmative determination is calculated in the SA-CA10 feedback control and the CA50 feedback control, respectively, is prohibited.

Note that, although according to the present embodiment a configuration is adopted in which, as described above, the maximum value of a value obtained by normalizing the cross-correlation coefficient R is used as the correlation index value I_{R}, a “correlation index value” in the present disclosure may also be the maximum value Rₘₐₓ of the cross-correlation coefficient R that is not accompanied by predetermined normalization processing. However, the correlation index value (that is, the maximum value Rₘₐₓ) in a case that is not accompanied by normalization processing does not simply increase as the degree of correlation increases, but rather the relation described hereunder exists between the size of the maximum value Rₘₐₓ and increases/decreases in the degree of correlation. That is, the degree of correlation increases as the maximum value Rₘₐₓ increases, and the degree of correlation becomes highest (that is, the two waveforms completely match) when the maximum value Rₘₐₓ becomes a certain value X. Further, when the maximum value Rₘₐₓ increases to a value greater than the value X, the degree of correlation decreases as the maximum value Rₘₐₓ increases. Accordingly, in the case of using the maximum value Rₘₐₓ as it is as the “correlation index value” without normalization processing, a determination as to whether or not the “correlation index value” is less than a “determination value” can be performed by the following processing. That is, in a case where the maximum value Rₘₐₓ deviates from within a predetermined range that is centered on the value X, it can be determined that “the correlation index value is less than the determination value” and, conversely, in a case where the maximum value Rₘₐₓ falls within the aforementioned predetermined range, it can be determined that “the correlation index value is greater than or equal to the determination value”.

### (Specific Processing in Embodiment)

FIG. 11 is a flowchart illustrating a routine that the ECU 40 executes in the embodiment of the present disclosure. Note that the present routine is started at a timing at which the opening timing of the exhaust valve 22 has passed in each cylinder, and is repeatedly executed for each combustion cycle.

In the routine shown in FIG. 11, first, in step 100, the ECU 40 acquires the current engine operating conditions. The term “engine operating conditions” used here refers to mainly the engine speed, the intake air amount, the air-fuel ratio and the ignition timing. The engine speed is calculated using the crank angle sensor 42. The intake air amount is calculated using the air flow meter 44. The air-fuel ratio means a target air-fuel ratio, and can be calculated by referring to a map that defines the target air-fuel ratio in relation to the engine torque and the engine speed. The target air-fuel ratio is either of a predetermined lean air-fuel ratio that is used at a time of lean-burn operation and the theoretical air-fuel ratio. The ignition timing is an indicated value of an ignition timing that is used in the current combustion cycle (that is, a target ignition timing). When operating under the theoretical air-fuel ratio, the target ignition timing is determined by adopting the intake air amount and engine speed as principal parameters, while in the case of lean-burn operation a value in which the CA50 feedback control is reflected is used. For example, a target torque that is calculated based on the accelerator opening degree can be used as the engine torque.

Next, the ECU 40 proceeds to step 102 and determines whether or not the current operating region is a lean-burn operation region. Specifically, based on the target air-fuel ratio acquired in step 100, the ECU 40 determines whether the current operating region is a lean-burn operation region or is an operating region which uses the theoretical air-fuel ratio.

If the result of the determination in step 102 is negative, the processing of the current routine is promptly ended. In contrast, if the result of the determination in step 102 is affirmative, the ECU 40 proceeds to step 104. In step 104 reference data for MFB is calculated based on the engine operating conditions acquired in step 100. The reference data for MFB can be calculated, for example, according to the following equation (6). The calculation of MFB data utilizing equation (6) is a known calculation using a Wiebe function, and hence a detailed description thereof is omitted here. As described in the foregoing, in the present embodiment the calculation period α for calculating the correlation index value I_{R} is a crank angle period from the ignition timing (target ignition timing) SA until the opening timing EVO of the exhaust valve 22. In the present step 104, reference data for MFB is calculated using equation (6) taking the calculation period α as an object.

[Expression 4]

Where, in the above equation (6), c represents a prescribed constant. Further, m represents a shape parameter which be determined by referring to a map in which the shape parameter m is previously defined in relation to the engine operating conditions (more specifically, the engine speed, the intake air amount, the air-fuel ratio and the ignition timing acquired in step 100).

Next, the ECU 40 proceeds to step 106. In step 106, measured data for the heat release amount Q is calculated in accordance with the above described equations (1) and (2) based on measured data for the in-cylinder pressure P that is acquired from the in-cylinder pressure sensor 30 in the current combustion cycle.

Next, the ECU 40 proceeds to step 108. In step 108, the ECU 40 calculates a slope k_{B} of a latter-half portion of the waveform of the measured data for the heat release amount Q calculated in step 106. The slope k_{B} of the latter-half portion is calculated using measured data for the heat release amount Q in a crank angle period from a crank angle θ_{fix1} to the aforementioned crank angle θ_{EVO}. An object of the processing in the present step 108 is to calculate the slope k_{B} as a clue for classifying the pattern of the measured data for the heat release amount Q as one of the three waveform patterns described above. However, at a time point of the processing in the present step 108, because the aforementioned crank angle θ_{Qmax} is not identified, the crank angle θ_{Qmax} cannot be used as a starting point for calculating the latter half portion of the waveform of the measured data for the heat release amount Q. Therefore, in the present step, the crank angle θ_{fix1} that is set in advance as a crank angle that is predicted to be definitely after the crank angle θ_{Qmax} is taken as the calculation starting point. The slope k_{B}, is, specifically, calculated as a slope of a regression line with respect to data points (θ_{fix1}, Q_{fix1}), . . . , (θ_{EVO}, Q_{EVO}) on an xy-plane that takes the crank angle θ as an x-coordinate value and the heat release amount Q as a y-coordinate value.

Next, the ECU 40 proceeds to step 110. In step 110, the ECU 40 determines whether or not the slope k_{B} calculated in step 108 is equal to 0. If the result determined in step 110 is affirmative (k_{B}=0), since a determination can be made to the effect that the pattern of the measured data for the heat release amount Q is classified as the aforementioned waveform pattern 1, the ECU 40 proceeds to step 112. In step 112, measured data for MFB is calculated that is based on the measured data for the heat release amount Q calculated in step 106. Next, the ECU 40 proceeds to step 114. In step 114, the ECU 40 calculates the correlation index value I_{R} using the above described equation (4), taking the calculation period α as the object and using the reference data for MFB calculated in step 104 and the measured data for MFB calculated in step 112.

In contrast, if the result determined in step 110 is negative (k_{B≠}0), the ECU 40 proceeds to step 116. In step 116, the ECU 40 determines whether or not the slope k_{B} calculated in step 108 is a value such that k_{B}<0. If the result determined in step 116 is affirmative (k_{B}<0), since a determination can be made to the effect that the pattern of the measured data for the heat release amount Q is classified as the aforementioned waveform pattern 3, the ECU 40 proceeds to step 118. In step 118, the measured data for the heat release amount Q that is calculated in step 106 is corrected. The specific correction technique is as described above referring to FIG. 10, and in the present step a correction is performed based on the maximum heat release amount Qₘₐₓ (measured Qₘₐₓ). Next, the ECU 40 proceeds to step 120. In step 120, measured data for MFB is calculated based on the measured data for the heat release amount Q that is corrected in step 118. Next, the ECU 40 proceeds to step 122. In step 122, the ECU 40 calculates the correlation index value I_{R} using the above described equation (4), taking the calculation period α as the object and using the reference data for MFB calculated in step 104 and the measured data for MFB calculated in step 120.

If the result determined in step 116 is affirmative (k_{B}>0), since a determination can be made to the effect that the pattern of the measured data for the heat release amount Q is classified as the aforementioned waveform pattern 2, the ECU 40 proceeds to step 124. In step 124, the measured data for the heat release amount Q that is calculated in step 106 is corrected. Although the specific correction technique is as described above referring to FIG. 10, here a method for identifying two straight lines (that is, the straight line L₁ and the straight line L₂ shown in FIG. 10) that are necessary for calculating the maximum heat release amount Qₘₐₓ (predicted Qₘₐₓ) will be described. Since the straight line L₁ corresponds to the regression line calculated in step 108, the regression line is also used in the present step 124 as the straight line L₁. The straight line L₂ is calculated using measured data for the heat release amount Q in a crank angle period (crank angle θ_{fix2} to crank angle θ_{fix3}) in which the measured data for the heat release amount Q is predicted to rise rectilinearly. More specifically, the straight line L₂ is calculated as a regression line with respect to points (θ_{fix2}, Q_{fix2}), (θ_{fix3}, Q_{fix3}) on an xy-plane that takes the crank angle θ as an x-coordinate value and the heat release amount Q as a y-coordinate value. By identifying the straight lines L₁ and L₂ in this manner, the maximum heat release amount Qₘₐₓ (predicted Qₘₐₓ) can be calculated and the crank angle θ_{Qmax} can be identified. Refer to the description of FIG. 10 with regard to the operations performed after the crank angle θ_{Qmax} is identified.

Next, the ECU 40 proceeds to step 126. In step 126, measured data for MFB is calculated based on the measured data for the heat release amount Q that is corrected in step 124. Next, the ECU 40 proceeds to step 128. In step 128, the ECU 40 calculates the correlation index value I_{R} using the above described equation (4), taking the calculation period α as the object and using the reference data for MFB calculated in step 104 and the measured data for MFB calculated in step 126.

Following step 114, step 122 or step 128, the ECU 40 proceeds to step 130. In step 130, the ECU 40 determines whether or not the correlation index value I_{R} calculated in step 114, step 122 or step 128 is less than the predetermined determination value I_{Rth}. The determination value I_{Rth} used in the present step 120 is previously set as a value with which it can be determined whether noise of a certain level or more is superimposed.

If the result determined in step 130 is negative (I_{R}≧I_{Rth}), that is, if it can be determined that the measured data for MFB in the current combustion cycle is data that has a high degree of correlation with the reference data under the same operating conditions, the ECU 40 proceeds to step 132 in which the ECU 40 determines that noise of a certain level or more is not superimposed.

On the other hand, if the result determined in step 130 is affirmative (I_{R}<I_{Rth}), that is, if it can be determined that the measured data for MFB has a low degree of correlation with the reference data, the ECU 40 proceeds to step 134. In this case, since it can be determined that noise of a certain level or more is superimposed, in step 114 the SA-CA10 feedback control and the CA50 feedback control are stopped.

As described in the foregoing, the SA-CA10 feedback control and CA50 feedback control are executed per cylinder during lean-burn operation, the results of these feedback controls (that is, a correction amount that is based on the relevant feedback control) is reflected in the next combustion cycle of the same cylinder. The processing in the present step 114 is, more specifically, processing that, by maintaining a correction amount for the fuel injection amount that is based on the SA-CA10 feedback control and a correction amount for the ignition timing that is based on the CA50 feedback control at the previous values thereof, respectively (more specifically, values that are calculated in the previous combustion cycle), and not reflecting the measured CA10 and the measured CA50 that are calculated in the current combustion cycle in the respective correction amounts, stops these feedback controls. Note that, PI control is utilized as an example of the aforementioned feedback control performed as described with reference to FIG. 3. That is, an I-term (integral term) that utilizes a cumulative difference between a target vale (target SA-CA10 or the like) and a measured value (measured SA-CA10 or the like) is included in these feedback controls. Accordingly, in a case of utilizing the aforementioned difference in a past combustion cycle in order to calculate an I-term when resuming feedback control, it is desirable to ensure that a value in a combustion cycle in which noise is detected is not included.

According to the processing of the routine illustrated in FIG. 11 that is described above, the patterns of measured data for the heat release amount Q are classified into three waveform patterns, and the measured data for the heat release amount Q can be appropriately corrected in accordance with the type of waveform pattern that the relevant pattern is classified as. In addition, noise that is superimposed on the measured data can be detected based on the correlation index value I_{R} that is calculated taking reference data and measured data for MFB as objects. In a case where noise is detected, feedback control that utilizes measured data for MFB (that is, SA-CA10 feedback control and CA50 feedback control) is stopped. By this means, a measured CA10 or a measured CA50 in the current combustion cycle with respect to which there is a possibility that an error has arisen due to noise are prohibited from being reflected in the respective feedback controls. It is thereby possible to avoid a situation in which the accuracy of engine control deteriorates due to utilization of the aforementioned measured CA10 or measured CA50.

### (Advantages of Cross-Correlation Function)

In this connection, in the above described embodiment a cross-correlation function is used for calculating the correlation index value I_{R} that shows a degree of correlation between measured data and reference data for MFB. However, a technique for calculating a “correlation index value” in the present disclosure is not necessarily limited to a technique that uses a cross-correlation function. That is, the relevant calculation technique may be, for example, a technique that utilizes a value obtained by adding together the squares of differences (a so-called “residual sum of squares”) between the measured data and reference data for MFB at the same crank angles when taking a predetermined calculation period as an object. In the case of the residual sum of squares, the value decreases as the degree of correlation increases. A “correlation index value” in the present disclosure is, more specifically, set as a value that becomes larger as the degree of correlation increases. Accordingly, in the case of utilizing the residual sum of squares, it is sufficient to use the “correlation index value” as an inverse number of the residual sum of squares.

### Other Embodiments

In this connection, in the above described embodiment, in a case where the correlation index value I_{R} is less than the determination value I_{Rth}, by maintaining the respective correction amounts of the SA-CA10 feedback control and the CA50 feedback control at the previous values thereof, reflection of the measured CA10 or measured CA50 in a combustion cycle in which the relevant correlation index value I_{R} is calculated in the respective feedback controls is prohibited. However, the manner of such prohibition is not limited to a case that maintains the previous values of the correction amount, and for example, a configuration may be adopted in which the respective correction amounts are set to zero. If the correction amounts are maintained at the previous values, although feeding back of the measured CA10 and the like in the current combustion cycle is stopped, adjustment of a fuel injection amount and the like is continued using a past feedback result is continued. On the other hand, if the correction amount is set to zero, utilization of a past feedback result is itself also prohibited. Further, a configuration may also be adopted that rather than prohibiting the aforementioned feedback controls, performs the feedback controls while lowering a feedback gain. This technique corresponds to an example in which a degree to which the measured CA10 and the like in the current combustion cycle is reflected in the SA-CA10 feedback control and the like is lowered in comparison to a case where the correlation index value I_{R} is equal to or greater than the determination value I_{Rth}.

Further, although SA-CA10 feedback control and CA50 feedback control are illustrated in the above described embodiment, “engine control that controls an actuator of an internal combustion engine based on a measured value at a specified fraction combustion point” in the present disclosure is not limited to the above described feedback control. That is, the specified fraction combustion point CAα can be used for determining torque fluctuations or misfiring of the internal combustion engine. Accordingly, control of a predetermined actuator that is performed upon receiving a result of the aforementioned determination is also included in the above described engine control. Further, the specified fraction combustion point CAα that is used as an object of “engine control” in the present disclosure is not limited to CA10 and CA50, and may be an arbitrary value that is selected from within a range from CA0 to CA100, and for example may be CA90 that is the 90% combustion point. In addition, for example, a combination of a plurality of specified fraction combustion points CAα may be used, such as CA10 to CA50 that is a crank angle period from CA10 to CA50.

Further, although in the above described embodiment an example is described in which the degree of correlation of MFB data is evaluated for each cylinder using a cross-correlation function, a configuration may also be adopted in which evaluation of the degree of correlation of MFB data is executed for an arbitrary representative cylinder as the object, and a predetermined countermeasure is implemented that takes all the cylinders as an object when noise is detected.

Further, in the above described embodiment, an example is described in which the fuel injection amount is adjusted by means of the SA-CA10 feedback control. However, an object of adjustment by the SA-CA10 feedback control that is utilized for combustion control during lean-burn operation is not limited to a fuel injection amount, and may be an intake air amount or ignition energy. Note that, if the object of adjustment is the fuel injection amount or the intake air amount, the feedback control can be positioned as air-fuel ratio control. Further, a specified fraction combustion point CAα that is used in the present feedback control is not necessarily limited to CA10, and may be another combustion point. However, with regard to application to the present feedback control, it can be said that CA10 is better in comparison to the other combustion points for the following reasons. That is, in a case where a combustion point within the main combustion period (CA10 to CA90) that is after CA10 is utilized, the crank angle period that is obtained will be affected to a large degree by parameters (EGR rate, intake air temperature and tumble ratio and the like) that affect combustion when the flame is spreading. That is, a crank angle period obtained in this case is not one that is focused purely on the air-fuel ratio, and is vulnerable to external disturbances. Further, as described above, an error is liable to arise at combustion points around the combustion starting point CA0 and the combustion end point CA100 due to the influence of noise that is superimposed on an output signal from the in-cylinder pressure sensor 30. The influence of such noise decreases as the combustion point moves away from the combustion starting point CA0 and the combustion end point CA100 in the direction of the center side of the combustion period. In consideration of these points, it can be said that CA10 is best.

Furthermore, in the above described embodiment, a configuration is adopted in which, at a time of lean-burn operation accompanied by implementation of SA-CA10 feedback control and CA50 feedback control, evaluation of the degree of correlation of MFB data is performed based on the correlation index value I_{R} and the like. However, on the premise that engine control based on the specified fraction combustion point CAα is being performed, the relevant evaluation is not limited to a time of lean-burn operation, and for example a configuration may be adopted in which the relevant evaluation in performed at a time of operation during combustion at the theoretical air-fuel ratio.

Further, in the above described embodiment, because the waveform pattern of the reference data for MFB is close to the waveform pattern 1, when the waveform pattern of the measured data for the heat release amount Q is the waveform pattern 2 or the waveform pattern 3, the relevant measured data is corrected and the waveform pattern 2 or waveform pattern 3 is aligned with the waveform pattern 1. However, there are cases where, due to the method of setting the reference data for MFB changing, the waveform pattern of the relevant reference data becomes close to the waveform pattern 2, and also cases where the waveform pattern of the relevant reference data becomes close to the waveform pattern 3. Accordingly, the waveform pattern of the measured data for the heat release amount Q that is to be aligned with may be changed in accordance with the waveform pattern of the reference data for MFB that is set.

Furthermore, in the above described embodiment, the measured data for the heat release amount Q is corrected before calculate the measured data for MFB. However, a configuration may also be adopted in which, after calculate the measured data for MFB using the above described equation (3) without correcting the measured data for the heat release amount Q, the relevant measured data for MFB is directly corrected so as to be aligned with the waveform pattern 1. Thus, as long as a data correction technique is a technique that is capable of, at a stage prior to calculate the correlation index value I_{R}, subjecting a waveform pattern of MFB data in a crank angle period after a combustion period in which measured data for MFB approaches an upper limit fraction to an alignment which is an alignment between reference data and measured data, the data correction technique can be applied to the present disclosure as a modification of the above described embodiment.

1. A control device for an internal combustion engine, comprising:
an in-cylinder pressure sensor that is configured to detect an in-cylinder pressure;
a crank angle sensor that is configured to detect a crank angle; and
a control unit that is configured to:
calculate measured data for mass fraction burned that is synchronized with a crank angle, based on an in-cylinder pressure that is detected by the in-cylinder pressure sensor and a crank angle that is detected by the crank angle sensor;
execute engine control in which a measured value at a specified fraction combustion point that is a crank angle at a time that mass fraction burned becomes a specified fraction is calculated based on measured data for mass fraction burned and an actuator of the internal combustion engine is controlled based on the measured value at the specified fraction combustion point;
calculate a correlation index value showing a degree of correlation between the measured data for mass fraction burned and reference data for mass fraction burned which is based on operating conditions of the internal combustion engine; and
prior to calculate the correlation index value, correct the measured data for mass fraction burned in a crank angle period that is after a combustion period in which mass fraction burned approaches an upper limit fraction, so that a pattern of the measured data for mass fraction burned in the crank angle period and a pattern of the reference data for mass fraction burned in the crank angle period become identical;
wherein the control unit is also configured to:
when the correlation index value is less than a determination value, prohibit reflection of a measured value at a specified fraction combustion point in a combustion cycle in which the correlation index value is calculated in the engine control, or lower a degree to which the measured value is reflected in the engine control in comparison to a case where the correlation index value is equal to or greater than the determination value.

2. The control device for an internal combustion engine according to claim 1,
wherein a pattern of the reference data for mass fraction burned in the crank angle period is a flat pattern in which mass fraction burned is constant,
wherein the control unit is also configured to correct the measured data for mass fraction burned in the crank angle period so that a pattern of the measured data for mass fraction burned in the crank angle period becomes the flat pattern.
